(19) United States
(12) Patent Application Publication
(10) Pub. No.: US 2009/0178096 A1
(43) Pub. Date: Jul. 9, 2009

(54) INTELLIGENT OVER-TRANSMISSION OF MEDIA DATA SEGMENTS

(75) Inventors: Valerian Menn, Redmond, WA (US); Nicholas Fang, Redmond, WA (US); Gurpratap Virdi, Bellevue, WA (US); Todd Bowra, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/969,219

(22) Filed: Jan. 3, 2008

(51) Int. Cl. H04N 7/173

(52) U.S. Cl. 725/114; 725/105

(57) ABSTRACT

An intelligent multi-sending of data stream segments is disclosed. One embodiment comprises monitoring one or more variable data transmission parameters, detecting one or more invariant media data segment parameters, assigning a value to the media data segment based upon the one or more invariant media data segment parameters and the one or more variable data transmission parameters, comparing the value to a threshold, and sending multiple copies of the media data segment over a network link to a media receiver if the value is above the threshold.

### BACKGROUND

As computing and communication networks continue to evolve, media is increasingly being stored, shared, and played over these networks. However, network-based media players can be adversely impacted by network constraints. For example, a wireless network may not have sufficient bandwidth for glitch-free playback of streamed media.

Some network-based media players enable a user to stream PC-based TV and media content to network-connected consumer electronics devices elsewhere in the home. When connected via a wireless network, such media players may experience packet loss during media streaming. When confronted with packet loss, a media player has two choices. First, the media player may skip the lost packets and play what content it has. This may result in image corruption onscreen. Second, the media player may request retransmission of the lost packets and delay playback until those packets are received. This may result in the video playback pausing during retransmission.

One approach to such issues involves sending duplicate copies of every packet (“multi-sending”). This approach decreases the probability that a packet will not be received, but may overload wireless networks and may therefore generate more packet loss. Another approach may comprise multi-sending only key frame data when a network is congested. However, hard-coded approaches are ultimately of limited use due to the dynamic nature of wireless networks.

### SUMMARY

Accordingly, various embodiments for predictive multi-sending of media data segments are described below in the Detailed Description. For example, one embodiment comprises monitoring one or more variable data transmission parameters, detecting one or more invariant media data segment parameters, assigning a value to the media data segment based upon the one or more invariant media data segment parameters and the one or more variable data transmission parameters, comparing the value to a threshold, and sending multiple copies of the media data segment over a network link to a media receiver if the value is above the threshold.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of an embodiment of a home media environment.

FIG. 2 shows a block diagram of embodiments of a media server and a media receiver of the home media environment of FIG. 1.

FIG. 3 shows a process flow depicting an embodiment of a method for predictive multi-sending of data stream segments.

### DETAILED DESCRIPTION

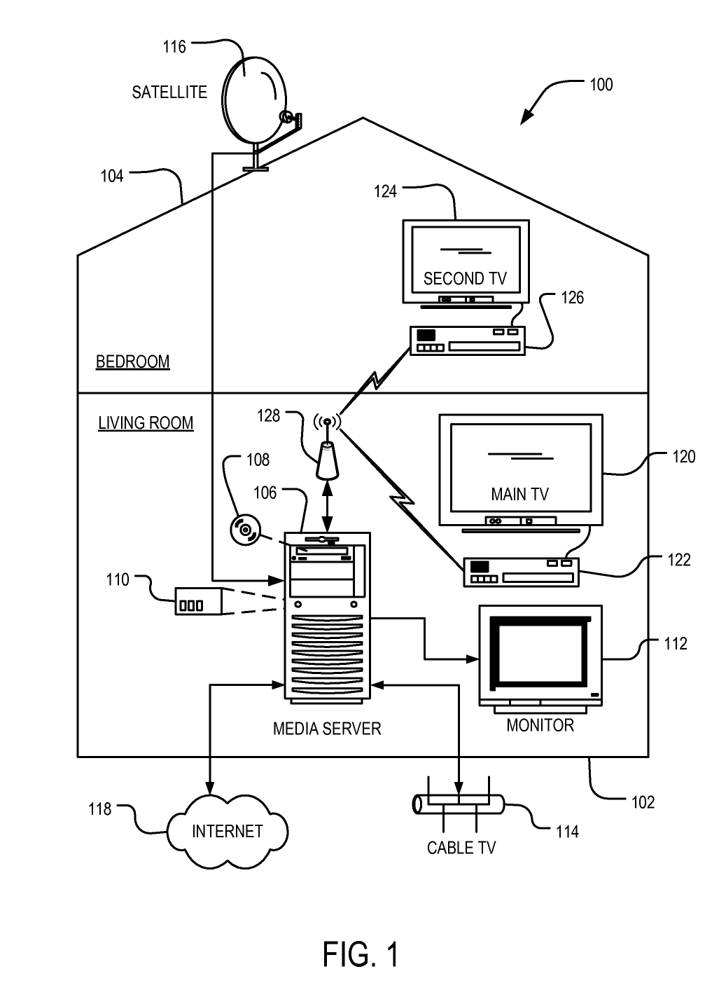

Prior to discussing embodiments for predictive multi-sending of data stream segments, an example streaming media use environment is described. FIG. 1 depicts an exemplary home entertainment environment 100, including a living room 102 and a bedroom 104. Central to the home entertainment environment 100 is a media server 106, in this implementation situated in the living room 102, but which could be located anywhere within the house or in communication with devices in the house through a network 128. In one implementation, the media server 106 is a conventional personal computer (PC) configured to run a multimedia software package, for example, a Windows Vista Ultimate operating system with Windows Media Center (available from Microsoft Corporation of Redmond, Wash.). In such a configuration, the media server 106 is able to integrate full computing functionality with a complete home entertainment system into a single PC. For example, a user can watch television (TV) in one graphical window of an attached video monitor 112, while sending e-mail or working on a spreadsheet in another graphical window on the same monitor 112. In addition, the media server 106 may also include other features or components, for example: a digital video recorder (DVR) to capture video content for future viewing or to record the future broadcast of a single program or series; a compact disc (CD) or digital video disc (DVD) drive 108 for disc media playback; a memory drive 110 for integrated storage of and access to a user's recorded content, such as TV shows, songs, pictures, data, media, and home videos; and an electronic program guide (EPG) (not shown in FIG. 1).

Instead of a conventional PC, the media server 106 may comprise a variety of other devices capable of storing and distributing media data, including, for example, a notebook or portable computer, a tablet PC, a workstation, a server, an Internet appliance, a DVR, or combinations thereof. The media server 106 may also be a set-top box capable of delivering media data to a computer where it may be streamed, or the set-top box itself could stream the media data. As the media server 106 may be a full function computer running an operating system, the user may also have the option to run standard computer programs (e.g., word processing and spreadsheets), send and receive e-mails, browse the Internet, or perform other functions.

In addition to storing media data, the media server 106 may be connected with a variety of media sources, for example, a cable connection 114, a satellite receiver 116, an antenna (not shown), and/or a network such as the Internet 118. A user may thus control a live stream of media data (e.g., TV content) received, for example, via the cable connection 114, the satellite receiver 116, or antenna. This capability may be enabled by one or more tuners residing in the media server 106. The one or more tuners may alternatively be located remote from the media server 106. In either case, the user may choose a tuner to fit any particular preferences. For example, a user wishing to watch both standard definition (SD) and high definition (HD) content may employ a tuner configured for both types of content. Alternately, the user may employ an SD tuner for SD content and an HD tuner for HD content separately.

The TV content may be received as an analog (i.e., radio frequency) signal or a digital signal (e.g., digital cable). The received TV content may include discrete content packets, where each content packet includes actual TV content (i.e., audio and video data. If TV content is received as an analog signal, discrete content packets may be created from the analog signal.

The entertainment environment 100 may also include one or more network devices functioning as media receivers 122, 126 placed in communication with the media server 106 through a network 128, for example, a local area network (LAN). In an exemplary embodiment, each media receiver 122, 126 may be a Media Center Extender device, for example, an Xbox 360™ (Microsoft Corporation, Redmond, Wash.). The media receivers 122, 126 may also be implemented as any of a variety of conventional media rendering or computing devices, including, for example, a set-top box, a television, a video gaming console, a desktop PC, a notebook or portable computer, a workstation, an Internet appliance, a handheld PC, a cellular telephone or other wireless communications device, a personal digital assistant (PDA), a network capable device, or combinations thereof. Furthermore, the media receivers 122, 126 may include a tuner as described above.

The network 128 may comprise a wired and/or wireless network, for example, cable, Ethernet, WiFi, a wireless access point (WAP), or any other electronic, radio frequency or optical coupling means, including the Internet. The network 128 may enable communication between the media server 106, the media receivers 122 and 126, and any other connected device through packet-based communication protocols, such as Transmission Control Protocol (TCP), Internet Protocol (IP), Real-time Transport Protocol (RTP), User Datagram Protocol (UDP) and Real-time Transport Control Protocol (RTCP), or other packet based communication protocols, as examples. Communications may be transmitted directly between devices over a LAN, or they may be carried over a wide area network (WAN), for example, the Internet 118.

Entertainment environment 100 may include one or more video display devices, for example a main TV 120 in the living room 102, a secondary TV 124 in the bedroom 104, and a video monitor 112 in the entertainment environment 100. These video display devices may be connected with the media server 106 via the network 128 either directly or via the media receivers 122, 126. As shown in the example of FIG. 1, the main TV 120 and the secondary TV 124 may be coupled to the media receivers 122, 126 through conventional cables. The video monitor 112 may be coupled with the media server 106 directly via a video cable. The media server 106 and media receivers 122, 126 may alternatively be coupled with any of a variety of video and audio presentation devices, and/or by other couplings than conventional cables. Media data, including TV content, may thus be supplied to each of the video display devices 112, 120, 124 over the home network 128 from the media server 106 situated in the living room 102.

The media receivers 122, 126 may be configured to receive streamed media data, including video and TV content, from the media server 106. Media data, and particularly video and TV content, may be transmitted from the media server 106 to the media receivers 122, 126 as streaming media comprised of discrete content packets via the network protocols described above, or even other network protocols. The streamed media data may comprise IPTV (television content delivered over the Internet), SD, and HD content, including video, audio, and image files, decoded on the media receivers 122, 126 for presentation on the connected TVs 120, 124 or monitor 112. The media data may further be “mixed” with additional content, for example, an EPG, presentation content related to the media data, a web browser window, and other user interface environments transmitted from the media server for output on the TVs 120, 124 or the monitor 112. Such additional media data may be delivered in a variety of ways using different protocols, including, for example, standard Remote Desktop Protocol (RDP), Graphics Device Interface (GDI), Hypertext Markup Language (HTML), or other protocols providing similar functionality.

In addition to the media receivers 122, 126 and the video display devices 112, 120, 124, the media server 106 may be connected with other peripheral devices, including components such as a DVR, cable or satellite set-top boxes, speakers, a printer (not shown), etc. The media server 106 and/or media receivers 122, 126 may also enable multi-channel output for speakers. This may be accomplished through the use of digital interconnect outputs, such as Sony-Philips Digital Interface Format (S/PDIF) or TOSLINK®, enabling the delivery of Dolby Digital, Digital Theater Sound (DTS), or Pulse Code Modulation (PCM).

It will be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, media server 106, media receivers 122, 126, and any other suitable device such as personal computers, servers, laptop computers, hand-held devices, cellular phones, microprocessor-based programmable consumer electronics and/or appliances, routers, gateways, hubs and other computer networking devices.

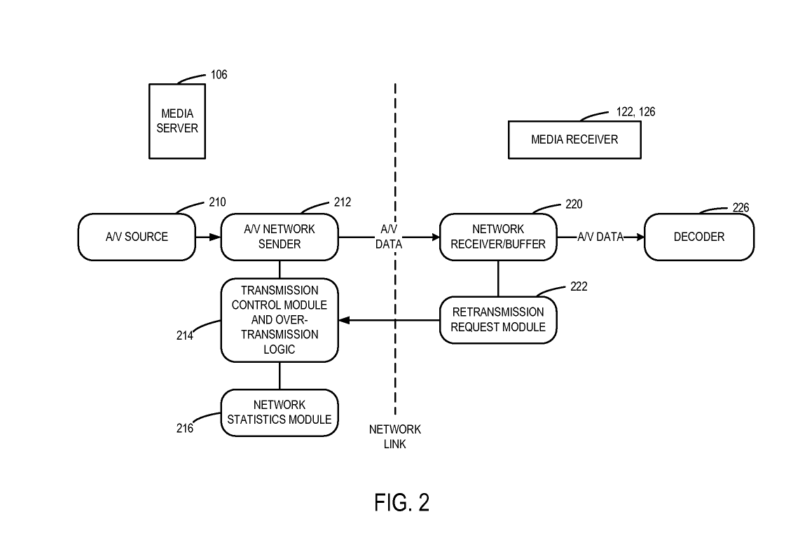

Continuing with the Figures, FIG. 2 shows a block diagram of a media server 106 and a media receiver 122 or 126 of the embodiment of FIG. 1. While the disclosure below related to the media receiver is made primarily with reference to media receiver 122, it will be understood that the disclosure also extends to media receiver 126, as well as other suitable media receivers. Further, while media receiver 122 may be described herein as a playback device, it will be understood that a media receiver may instead be coupled with a separate media playback device.

Media server 106 includes an audio/video (A/V) source 210 coupled to an A/V network sender 212 to transmit media data over a network link to media receiver 122 for playback. Media server 106 also comprises a transmission control module 214 that includes over-transmission logic. The term “over-transmission”, as used herein, refers to the multiple sending of a segment of data to reduce the probability that the segment of data will not be received by media receiver 122. The over-transmission logic is configured to decide whether any selected segment of data is to be over-transmitted. In this manner, the over-transmission of data may be tailored to the specific application-layer characteristics of the data being sent, as well as to real-time network constraints. By operating at an application layer, or any other layer above a transport layer, the over-transmission of segments may allow over-transmission of segments of a different size than a transport layer packet, including large application layer segments that span multiple transport packet layer packets, as well as multiple small segments that fit inside a single transport layer packet. This may allow some embodiments to control transport or network packet size to manage network bandwidth while also providing a more robust delivery of the data. While the over-transmission logic is depicted as residing on the media server 106, in other embodiments the over-transmission logic may reside on another device in communication with media server 106. The over-transmission logic is described in more detail below.

Continuing with FIG. 2, the transmission control module 214 is coupled to A/V network sender 212 and is configured to receive retransmission requests sent by media receiver 122 over a network link and forward them to A/V network sender 212. Such retransmission requests may be sent when the media receiver 122 fails to receive a packet, and therefore may help to further facilitate good playback performance. Transmission control module 214 is further configured to receive statistical network performance data from network statistics module 216. Such data may be used in determining whether to over-transmit a data segment, as described below. While the network statistics module 216 is depicted as residing on the media server 106 in FIG. 2, in other embodiments the network statistics module 216 may reside on the media receiver 122, or on a third device.

As depicted in the embodiment in FIG. 2, media receiver 122 includes a network receiver/buffer 220 configured to receive A/V data from A/V source 212, and a decoder 226 coupled with network receiver/buffer 220. Further, in some embodiments, media receiver 122 may include a retransmission request module 222 in communication with network receiver/buffer 220 and also in communication with transmission control module 214 over a network link. Retransmission request module 222 may be configured to selectively send retransmission requests to transmission control module 214 to request the retransmission of data not received by media receiver 122. It will be understood that in some embodiments, the retransmission request module 222 may be omitted, as over-transmission as disclosed herein may be performed without the use of retransmission requests. Further, while shown in the context of A/V data transmission, it will be appreciated that the disclosure herein may be used with the transmission of any suitable media data.

As mentioned above, the over-transmission logic on transmission control module 214 is configured to intelligently decide whether or not to over-transmit media data from media server 106 to media receiver 122 based upon various inputs. This allows the over-transmission logic to adjust the over-transmission behavior of transmission control module 214 in response to characteristics of the network, the transmitted media data, the media receiver 122, retransmission requests received, and/or any other suitable factor. For example, over-transmission may be reduced or temporarily disabled if the bandwidth of the network link decreases, or may be increased if the bandwidth of the network link increases.

The decision of whether to over-transmit a media data segment may be made on any suitable factor. For example, in some embodiments, the decision of whether to over-transmit a media data segment may be based upon a determined consequence of the omission of the media data segment on playback performance, and/or a determined consequence of over-transmission on network performance as well as playback performance. In light of such factors, over-transmission of the media data may be utilized when it would improve media playback, and not utilized when it would degrade media playback.

Various inputs may be used to decide whether over-transmission is a net benefit or detriment to media playback performance. Such parameters include, but are not limited to, invariant media data segment parameters, and/or variable data transmission parameters. Invariant media data segment parameters that may be considered include, but are not limited to, a characteristic of the media data segment being sent (i.e. key frame or predictive frame); a type of media file format (e.g. Windows Media Video (WMV) data, MPEG-2 (Motion Picture Experts Group), etc.), a type of media data (audio or video); a distance between key frames in a data stream; a distance from a current predictive frame to a next key frame, etc. Variable data transmission parameters that may be considered include, but are not limited to, a relative fullness of a network receiver/buffer 220, a network capacity, a network latency, a current network utilization, a capability of the media receiver 122, etc.

Any suitable number of different parameters may be used to make a determination of whether to over-transmit data. For example, in some embodiments, a combination of network bandwidth limitations and data type/frame type parameters may be taken into consideration. As a specific example, if a transmitted media data segment contains WMV key frame data, the loss of the media data segment may result in video image corruption that persists until the next key frame is played. However, WMV data key frames may be spaced relatively far apart (e.g. on the order of seconds). Therefore, where bandwidth limitations exist, any pause in playback due to lag introduced by the over-transmission of the media data segment on a bandwidth-limited network link may be less noticeable than a seconds-long glitch caused by the loss of data. On the other hand, if the media data segment contains media data from a WMV bi-directionally predicted frame, loss of the data may cause a glitch that is no longer noticeable within milliseconds. In this case, a pause in playback due to lag caused by the over-transmission may be more disruptive than the glitch caused by the loss of data. Therefore, where network bandwidth is too low to over-transmit data without introducing a pause in playback, a decision on whether to over-transmit data may be made based upon the relative disruption of over-transmission compared to a data loss in light of the data format type and data frame type.

Further, an over-transmission behavior of transmission control module 214 may be modified depending upon changes in bandwidth availability. For example, at times when a network bandwidth is approximately equal to a media data stream bit-rate, over-transmission may be disabled, as in this case over-transmission may saturate the network and induce packet loss. Likewise, if network capacity is greater than or equal to a media data stream bit-rate in combination with a bit-rate of sending a stream of key frames in the absence of any predictive frames, then the key frames in the media data may be over-transmitted while the predictive frames are sent only once. In this case, the number of copies over-transmitted frames may depend upon the amount of additional bandwidth present. Additionally, if it is determined that network capacity is between the above two cases, over-transmission may be enabled whereby a subset of key frames, such as a copy of every nth key frame for example, is over-transmitted such that the available bandwidth is utilized without saturating the network.

In some embodiments, the media server 106 may encode media data at an application layer using media frames such as WMV frames, MPEG-2 frames, etc. When these frames are sent over a network link, they may be sent using transport layer protocols such as User Datagram Protocol (UDP), other transport layer protocols, or even protocols from other layers. The media data frames are often a different size than the transport layer protocol packets. For example, a WMV key frame may be substantially larger than 64 Kilobytes (KB) while a UDP packet may be 1460 bytes. Therefore, instead of a 1:1 mapping between media frames and transport packets, media frames are distributed over multiple packets.

In such cases, the over-transmission logic may either over-transmit an entire application-level data frame, or may be configured to make decisions regarding a size of a segment of media data to over-transmit in order to provide improved playback of a data stream. For example, if a number of packets needed to provide improved playback of a data stream is low as compared to a relative importance of the media frame to playback quality, the over-transmission logic may request over-transmission. On the other hand, if a number of packets needed is high as compared to the relative importance of the media frame, the over-transmission logic may refrain from over-transmission.

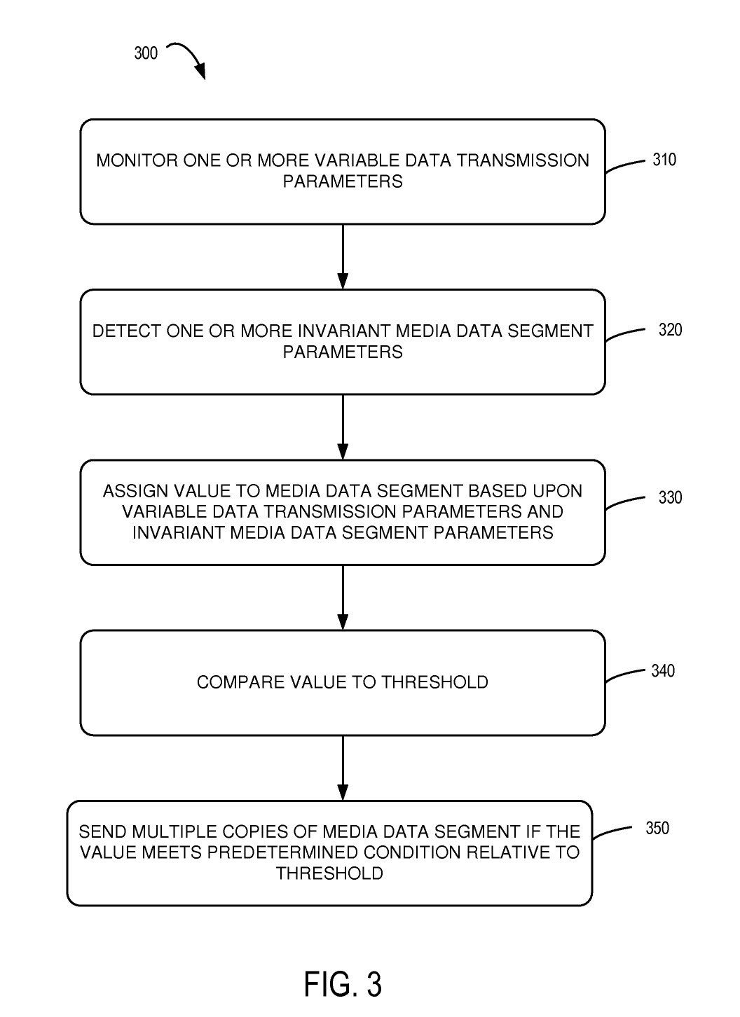

Continuing with the Figures, FIG. 3 shows a flow diagram of an embodiment of a method 300 for network media streaming that utilizes the intelligent over-transmission of media data segments. First, as indicated in block 310, method 300 comprises monitoring one or more variable data transmission parameters. This may comprise monitoring a network capacity, a network latency, a current network utilization, a buffer capacity on the receiving device, a capability of the receiving device, etc,

Method 300 also comprises detecting one or more invariant media data segment parameters to be sent to a media receiver, as indicated in block 320. Such media data segment parameters may include, but are not limited to, a characteristic of the media data segment being sent (i.e. key frame or predictive frame); a type of media file format (e.g. Windows Media Video (WMV) data, MPEG-2 (Motion Picture Experts Group), etc.), a type of media data (audio or video), a distance between key frames in a data stream, a distance from a current predictive frame to a next key frame, etc.

Next, method 300 comprises assigning a value to a media data segment based upon one or more of the variable data transmission parameters and one or more of the invariant media data segment parameters, as indicated at 330. The term “value” as used herein refers generally to a quantification or qualification of a media data segment that allows a determination of whether to request data over-transmission to be made. The term may refer to any suitable data type, for example a string, a digit, an alphanumerical character, etc., or any other suitable representation of value.

The invariant media data characteristics may have any suitable effect on the value assigned. For example, in some embodiments, a higher value may be assigned to key frame data and a lower value may be assigned to predictive frame data. The terms “higher value” and “lower value” as used herein signify a greater or lesser propensity toward over-transmission, respectively, and are not intended to signify an actual magnitude of the values. Likewise, a higher value may be assigned to WMV key frames than to MPEG-2 key frames, as the WMV key frames may be more widely separated than the MPEG-2 key frames.

In some embodiments, a higher value may be assigned to audio data than to video data, as gaps in audio data may be perceived more easily by a user than gaps in video data. In other embodiments, a higher value may be assigned to video data than for audio data, as the loss of a video key frame may cause a disruption of a longer duration than the loss of an audio frame. Whether audio is assigned a higher or lower value than video may depend upon variable parameters, such as a user-set preference for one or the other.

The variable data transmission parameters may also have any suitable effect and/or weighting on the value assigned to a media data segment. For example, a higher value may be assigned where it is determined that a receiving device buffer is relatively empty, while a lower value may be assigned where it is determined that a receiving device buffer is relatively full. Likewise, a higher value may be assigned where it is determined that a relatively larger amount of network bandwidth is available, while a lower value may be assigned where a relatively smaller amount of network bandwidth is available. Similarly, higher values may be assigned for lower network latency, higher network capacity, etc.

Continuing with FIG. 3, the assigned value is compared to a threshold, as indicated in block 340. The threshold may have a predetermined value, or may be variable depending upon one or more parameters. For example, the threshold may depend upon a user-input preference, for example, regarding whether audio or video quality is a more important feature to the view. Likewise, the threshold may depend upon a type of content being transmitted. As a specific example, a higher propensity to over-transmit data (i.e. a lower threshold) may be set for video data for a high-definition movie to take advantage of the playback quality, while a lower propensity to over-transmit data (i.e. a higher threshold) may be used for video data for a sporting event or the like, due to the real-time nature of the event being more important than high image quality. The threshold may also be set based upon a priority of media streaming compared to other network usage, upon a media server performance characteristic or characteristics, etc.

Next, if the value meets a preselected condition relative to the threshold (e.g. greater than the threshold, greater than or equal to the threshold, or other suitable condition), as indicated in block 350, method 300 comprises over-transmitting copies of the media data segment. Any suitable number of copies of a media data segment may be over-transmitted. For example, a greater number of copies of a media data segment may be sent for a key frame, while a lesser number of copies may be sent for a frame considered to be of lesser importance to playback quality, such as a predictive frame. A number of copies over-transmitted may also depend upon available bandwidth, where a greater number of copies are sent when more bandwidth is available.

While described herein in the context of a home streaming media environment, it will be appreciated that the concepts disclosed herein may be used in any suitable streaming media environment, including, but not limited to, other client-server-based use environments and peer-to-peer-based use environments. Furthermore, while the media server and media receiver are shown herein as being located on different devices, it will be understood that these components may comprise separate components, modules, programs or other entities running on a single device.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of intelligently sending multiple copies of a media data segment within a data stream, the method comprising:
monitoring one or more variable data transmission parameters;
detecting one or more invariant media data segment parameters;
assigning a value to the media data segment based upon the one or more invariant media data segment parameters and the one or more variable data transmission parameters;
comparing the value to a threshold; and
sending multiple copies of the media data segment over a network link to a media receiver if the value meets a predetermined condition relative to the threshold.

2. The method of claim 1, wherein the one or more invariant media data segment parameters comprises one or more of a frame type, a media file format, a type of media data, a distance between key frames in a data stream, and a distance from a current predictive frame to a next key frame.

3. The method of claim 1, wherein the one or more variable data transmission parameters comprises one or more of a network capacity, a network latency, a current network utilization, a buffer capacity on the media receiver, and a capability of the media receiver.

4. The method of claim 1, wherein the threshold is dependent upon one or more of a user-input preference, a type of content of the media data segment, a priority of streaming media compared to other network usage, and a media server performance characteristic.

5. The method of claim 1, wherein the threshold is fixed.

6. The method of claim 1, further comprising disabling the sending of multiple copies of the media data segment if the network capacity is equal to or less than a data stream bit-rate.

7. The method of claim 1, further comprising sending multiple copies of each key frame in the data stream and one copy of each predictive frame in the data stream, wherein a number of copies of key frames sent is based upon a network capacity.

8. The method of claim 1, further comprising sending multiple copies of a subset of key frames and one copy of each predictive frame in the data stream if the network capacity is less than a sum of a data stream bit-rate and a key frame bit-rate but is greater than the data stream bit-rate.

9. A computer-readable medium comprising instructions executable by a computing device to enable an intelligent sending of multiple copies of a media data segment in a data stream, wherein the media data stream comprises key frame data and predictive frame data, the instructions being executable to perform a method comprising:
monitoring one or more variable data transmission parameters;
detecting one or more invariant media data segment parameters;
assigning a value to the media data segment based upon the one or more invariant media data parameters and the one or more variable data transmission parameters;
comparing the value to a threshold dependent upon one or more of a user-input preference, a content type of the media data segment, a priority of streaming media compared to other network uses, and a media server performance characteristic; and
sending a plurality of copies of the media data segment over a network link to a media receiver if the value meets a predetermined condition relative to the threshold.

10. The computer-readable medium of claim 9, wherein the one or more invariant media data segment parameters comprises one or more of a frame type, a media file format, a type of media data, a distance between key frames in a data stream, and a distance from a current predictive frame to a next key frame.

11. The computer-readable medium of claim 9, wherein the one or more variable data transmission parameters comprises one or more of a network capacity, a network latency, a current network utilization, a buffer capacity on the media receiver, and a capability of the media receiver.

12. The computer-readable medium of claim 9, further comprising instructions for disabling the sending of multiple copies of the media data segment if the network capacity is equal to or less than a data stream bit-rate.

13. The computer-readable medium of claim 9, further comprising instructions for sending multiple copies of each key frame and one copy of each predictive frame in the data stream, wherein a number of copies of key frames sent is based upon the network capacity.

14. A network media server, comprising:
a network sender to send a stream of media data over a network link; and
a transmission control module in communication with the network sender, wherein the transmission control module is configured to:
monitor one or more variable data transmission parameters;
detect one or more invariant media data segment parameters;
assign a value to a media data segment based upon the one or more variable data transmission parameters and the one or more invariant media data segment parameters;
compare the value against a threshold; and
send multiple copies of the media data segment over a network link to a media receiver if the value meets a predetermined condition relative to the threshold.

15. The network media server of claim 14, wherein the one or more invariant media data segment parameters comprises one or more of a frame type, a media file format, a type of media data, a distance between key frames in a data stream, and a distance from a current predictive frame to a next key frame.

16. The network media server of claim 15, wherein the one or more variable data transmission parameters comprises one or more of a network capacity, a network latency, a current network utilization, a buffer capacity on the media receiver, and a capability of the media receiver.

17. The network media server of claim 14, wherein the threshold is dependent upon one or more of a user-input preference, a content type of the media data segment, a priority of streaming media compared to other network uses, and a media server performance characteristic.

18. The network media server of claim 14, wherein the threshold is fixed.

19. The network media server of claim 14, wherein the transmission control module is configured to disable sending of multiple copies of the media data segment if the network capacity is equal to or less than a data stream bit-rate.

20. The network media server of claim 14, wherein the transmission control module is configured to send multiple copies of a subset of the key frames and one copy of each predictive frame in the data stream if the network capacity is less than a sum of a data stream bit-rate and a key frame bit-rate but is greater than the data stream bit-rate.
